(19) United States
(12) Patent Application Publication
(10) Pub. No.: US 2006/0103745 A1
(43) Pub. Date: May 18, 2006

(54) Image sensor and image sensor system

(76) Inventors: Yuji Nagaishi, Daito-shi (JP); Kazuo Okamoto, Hirakata-shi (JP); Takuma Chiba, Ibaraki-shi (JP); Tatsuro Juri, Osaka-shi (JP)

Correspondence Address: RATNERPRESTIA, P.O. BOX 980, VALLEY FORGE, PA, 19482, US

(21) Appl. No.: 11/268,994

(22) Filed: Nov. 8, 2005

(30) Foreign Application Priority Data
Nov. 8, 2004 (JP) P2004-323692
Jun. 6, 2005 (JP) P2005-165587

(51) Int. Cl. H04N 5/335

(52) U.S. Cl. 348/294

(57) ABSTRACT

A MOS image sensor and an imaging apparatus using this image sensor enable controlling sensor driving with a high degree of freedom using a simple control circuit design and minimal wiring lines. The light reception unit of the image sensor in this imaging apparatus is segmented into a plurality of areas and conventional shift registers are constructed in multiple layers, thus enabling controlling the multiple sensor areas by means of a relatively simple circuit design. The imaging apparatus can thus locally change exposure and imaging conditions in parts of a single frame. Problems due to underexposure and overexposure are thus suppressed, and images with a wide dynamic range can be captured.

### BACKGROUND OF THE INVENTION

1. Field of Technology

The present invention relates to a metal oxide semiconductor (MOS) image sensor and to an imaging apparatus that uses this MOS image sensor, and relates more particularly to the structure and control of an image sensor enabling imaging with a wider dynamic range than conventionally.

2. Description of Related Art

MOS image sensors (including both NMOS and CMOS image sensors) are developing rapidly as the next-generation successor to CCD image sensors for applications in both video and still portable digital cameras, hand-held cameras, and cell phone cameras. Advantages of MOS sensors compared with CCD sensors include being drivable with a single power supply, manufacturable at a low cost, and offering multifunctional performance. MOS image sensors have an amplifier circuit for the photoreceptor of each pixel, and in principle enable driving each pixel independently. For example, MOS image sensors in principle enable controlling the charge accumulation time independently for each pixel, and freely controlling the sequence in which the accumulated charges are read. As a result, MOS image sensors afford significantly greater freedom of control when compared with CCD image sensors.

On the other hand, the pixel pitch in image sensors has been trending toward higher resolution, and as resolution increases it also becomes more difficult to assure an aperture ratio that can pass sufficient light to the photodiode (or equivalent element). This makes it necessary to minimize the size of the wiring and control circuitry for each pixel in order to assure a sufficiently high aperture ratio.

FIG. 1 is a schematic diagram of a conventional MOS image sensor. Each pixel 11 has a photodiode and amplifier, and is connected to a line selection register 12, column selection register 13, and a reset control register 14 for eliminating the charge accumulated in the photodiode. The line selection register 12, column selection register 13, and reset control register 14 are shift registers.

In a MOS image sensor, the line selection register 12, column selection register 13, and reset control register 14 disposed around the light reception unit each consist of a single shift register. As shown in FIG. 1, the line selection register 12 is connected to all pixels in the same line via a common wiring line. The column selection register 13 and reset control register 14 also share a common wiring line, thus simplifying the circuit structure. The circuit design is thus made as simple as possible and the wiring lines are kept as few as possible.

As noted above, MOS image sensors in principle enable imaging with a very high degree of freedom, but the circuit design and wiring used for controlling each pixel in current MOS image sensors are kept simple in order to assure good sensitivity to light. As a result, currently available MOS image sensors are capable of only basic control for changing access to pixels in a specific sequence in the column and line alignment directions using shift registers, for example. As a result, the charge reset and charge reading timing are the same for all pixels when capturing the image in one frame, and the exposure time is therefore the same for all pixels. All pixels are thus controlled at the same uniform timing in each single imaging operation. The charge accumulation time (exposure time) is therefore the same for all pixels in one imaging operation (imaging one frame). As a result, underexposure and loss of gradation in blacks occurs in pixels where there is not enough light (such as in shadows and dark image areas), and pixels exposed to too much light become washed out with a similar loss of gradation (such as in highlights and bright image areas).

Japanese Unexamined Patent Appl. Pub. 2003-32556 teaches a principle of an imaging method enabling pixel level control that addresses this problem. More specifically the charge accumulation time is varied by controlling charge elimination and charge output pixel by pixel, and reading is controlled pixel by pixel to enable capturing images with a high degree of freedom. Although Japanese Unexamined Patent Appl. Pub. 2003-32556 does not teach the structure of the control circuit, this control method requires controlling driving a MOS image sensor pixel by pixel, and the control circuit is likely complex. Furthermore, if the wiring lines in the light reception unit of the image sensor are increased as a result of the control circuit becoming more complex, the aperture ratio of the light reception unit is also reduced. A lower aperture ratio reduces the sensitivity of the image sensor to light. At present, providing a MOS image sensor having a complex circuit design with sufficient light sensitivity is difficult.

### SUMMARY OF THE INVENTION

The present invention is directed to solving the foregoing problem, and an object of this invention is to provide an image sensor enabling drive control with a high degree of freedom using a simple control circuit design and minimal wiring lines. A further object is to provide an imaging apparatus using this image sensor.

To achieve the foregoing object, a first aspect of the present invention is an image sensor having a light reception unit segmented into a plurality of areas, each area having a plurality of pixels; an area identification unit to identify one of the plurality of areas; a start timing control unit to control a start timing of charge accumulation in the pixels in the identified area; and an output timing control unit to control timing for outputting the charge accumulated in the pixels in the identified area.

Preferably, the image sensor is a MOS image sensor.

Alternatively, the area identification unit of this image sensor is a shift register.

Yet alternatively, the area identification unit of this image sensor is a decoder.

Further preferably, the start timing control unit has: a first start timing control unit to control the start of charge accumulation in the pixels aligned in a first column in a predefined direction; and a second start timing control unit to control the start of charge accumulation in the pixels aligned in a second column adjacent and parallel to the first column, and wherein the output timing control unit has: a first output timing control unit to control the start of outputting a charge accumulated in the pixels aligned in the first column; and a second output timing control unit to control the start of outputting a charge accumulated in the pixels aligned in the second column.

Yet further preferably, the plurality of areas are divided into P groups, where the P is an integer more than one, the area identification unit identifies one area in each of the P groups, the start timing control unit controls the start of charge accumulation in the pixels in the one identified area for each group, and the output timing control unit controls the start of outputting the charge accumulated in the pixels in the one identified area for each group.

Another aspect of the present invention is an imaging apparatus using an image sensor as described above, and having a control unit to control at least one of the area identification unit, the start timing control unit, and the output timing control unit at a specific timing; and a timing determination unit to determine the specific timing. The timing determination unit determines the specific timing for each area, and the image sensor captures an image based on the specific timing.

Preferably, the image sensor is a MOS image sensor.

Alternatively, the specific timing is determined in this imaging apparatus based on an average luminance in each area.

Yet alternatively, the specific timing is determined based on a focal point, that is, the specific timing is determined based on a focusing condition in each area.

Further preferably, the control unit outputs a first signal, and the start timing control unit eliminates, based on the first signal, charges accumulated in the pixels in the identified area; and the control unit outputs a second signal, and the output timing control unit outputs, based on the second signal, the charges newly accumulated in the pixels in the identified area after the charge elimination, thereby forming an image.

Yet further preferably, the control unit outputs a third signal, and the area identification unit identifies, based on the third signal, the identified area.

Further aspect of the present invention is an image sensing method including: segmenting a light reception unit into a plurality of areas, each area having a plurality of pixels; identifying one of the plurality of areas; controlling a start timing of charge accumulation in the pixels in the identified area; and controlling a timing for outputting the charge accumulated in the pixels in the identified area.

Yet further aspect of the present invention is an imaging method including: segmenting a light reception unit into a plurality of areas, each area having a plurality of pixels; identifying one of the plurality of areas; controlling a start timing of charge accumulation in the pixels in the identified area; controlling a timing for outputting the charge accumulated in the pixels in the identified area; performing at least one of the identifying, the controlling the start timing of charge accumulation, and the controlling the timing for outputting at a specific time; determining the specific time; and capturing an image at the specific time.

### ADVANTAGEOUS EFFECT OF THE INVENTION

An image sensor and imaging apparatus using this image sensor according to the present invention reduces conventional problems from underexposure in dark image areas and overexposure in bright image areas, and thus provides a wider dynamic range than conventionally while using a circuit design and wiring comparable in simplicity to a conventional MOS image sensor such as shown in FIG. 1.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a schematic diagram of a conventional MOS image sensor;

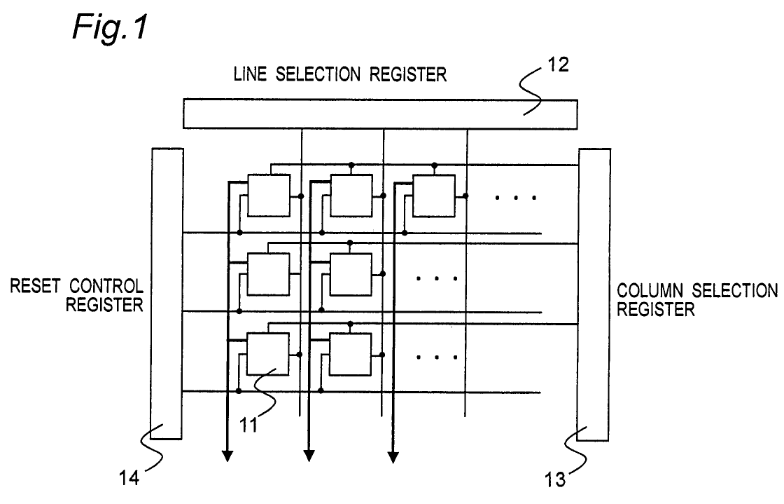

FIG. 2 is a block diagram of an imaging apparatus according to the present invention;

FIG. 3 is a schematic diagram of an image sensor according to a first embodiment of the present invention;

FIG. 4 is a block diagram showing the control of an image sensor according to a first embodiment of the present invention;

FIG. 5 is a block diagram showing the control of an image sensor according to a first embodiment of the present invention;

FIG. 6 is a block diagram showing in detail the control of an image sensor according to a first embodiment of the present invention;

FIGS. 7A and 7B are diagrams showing the relationship between the light reception unit of the image sensor and the rectangular areas;

FIGS. 8A and 8B are diagrams showing the sequence of charge elimination and charge output;

FIG. 9 is a diagram showing the relationship between the timing at which charge accumulation starts and the accumulated charge is output;

FIG. 10 is a time chart showing the relationship between the reset timing and line-column selection timing in each pixel, and the timing relationship between pixels;

FIG. 11 is a time chart showing the arrangement of the three color pixel units used for calculating the luminance information;

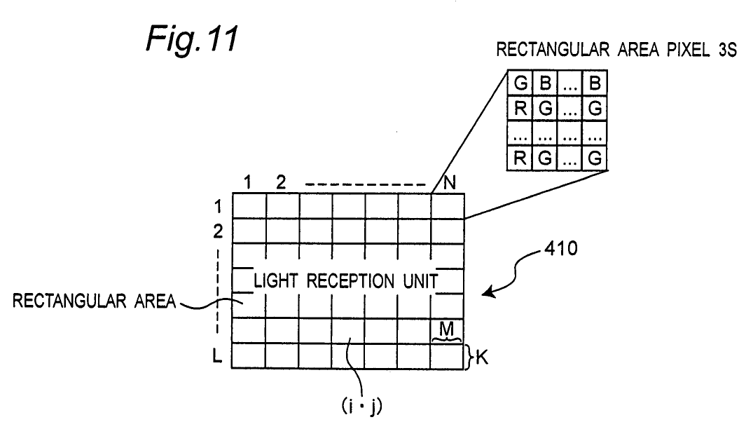

FIG. 12 is a time chart showing the relationship between luminance information and reset timing;

FIG. 13 is a diagram showing a method of correcting luminance at the border between adjacent rectangular areas;

FIG. 14 is a block diagram of an imaging apparatus according to the present invention;

FIG. 15 is a block diagram of an image sensor according to a second embodiment of the present invention;

FIG. 16 is a block diagram showing in detail the control of an image sensor according to a second embodiment of the present invention;

FIG. 17 is a block diagram of an imaging apparatus according to a third embodiment of the present invention;

FIG. 18 is a block diagram of an image sensor according to a third embodiment of the present invention;

FIG. 19 is a diagram showing the sequence of charge elimination and charge output;

FIG. 20 is a block diagram of an imaging apparatus according to a fourth embodiment of the present invention;

FIG. 21 is a block diagram of an image sensor according to a fourth embodiment of the present invention; and

FIG. 22 is a diagram showing the sequence of charge elimination and charge output.

### DETAILED DESCRIPTION OF THE PREFERRED EMBODIMENTS

Preferred embodiments of a MOS image sensor and an imaging apparatus using a MOS image sensor according to the present invention are described below with reference to the accompanying figures.

### Embodiment 1

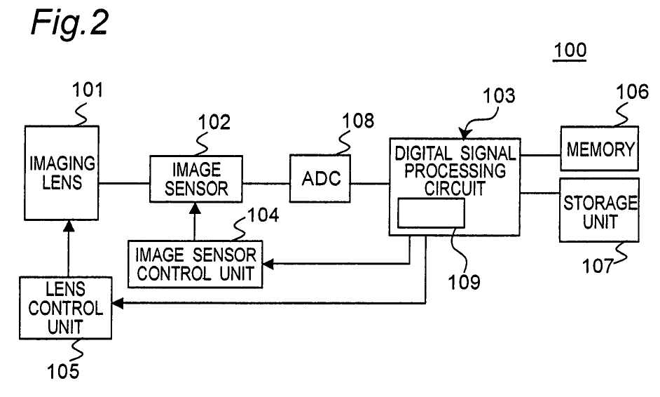

FIG. 2 is a block diagram of a digital camera 100a as an imaging apparatus using a MOS image sensor according to the present invention. The arrangement of this digital camera 100a is described first below.

As shown in FIG. 2, the digital camera 100a has an imaging lens 101, image sensor 102, digital signal processing circuit 103, image sensor control unit 104, lens control unit 105, memory 106, storage unit 107, and analog/digital conversion unit (ADC) 108.

The operation of these components of the digital camera (imaging apparatus) 100a is described next.

Light from a subject that is incident on the imaging lens 101 is collected by the imaging lens 101 controlled by the lens control unit 105 and focused on the light reception unit of the image sensor 102. The image sensor 102 thus photoelectrically converts the incident subject light. The image sensor control unit 104 controls sending the charges accumulated in the image sensor 102 as a result of this photoelectric conversion to the ADC 108 as analog signals. After clamping by the ADC 108, the resulting digital signals are sent to the digital signal processing circuit 103.

The digital signal processing circuit 103 temporarily stores the digital signals from the ADC 108 in buffer memory 106. The digital signal processing circuit 103 then reads the stored digital signals, generates luminance and color difference signals from the digital signals, and then applies noise reduction, gamma correction, and aperture processes to the luminance and color difference signals. The digital signal processing circuit 103 also compresses the signals to JPEG image signals, and writes the JPEG signals to memory 106. The JPEG data written to memory 106 is then output to storage unit 107 as necessary.

This storage unit 107 is a flash memory card in this embodiment of the invention. The storage unit 107 of the digital camera 100a shall not be limited to flash memory devices, however, and other storage media usable in digital cameras can be used.

The operation described to this point is common in other types of digital cameras. The process whereby the charge accumulation and output (read) timing is determined in a digital camera 100a according to this embodiment of the invention is executed by the digital signal processing circuit 103 as further described below. Based on the resulting timing, the image sensor control unit 104 controls the timing at which the charge accumulation by the image sensor 102 starts and ends. This timing determination process and imaging control are described below.

Note that the digital signal processing circuit 103 functions as the timing determination unit of the accompanying claims, and the image sensor control unit 104 is the control unit of the accompanying claims for controlling imaging by the image sensor.

As long as the power is on, a digital camera according to this embodiment of the invention continuously photoelectrically converts light received by the image sensor 102 and sends an analog signal based on the accumulated charge to the ADC 108 even when images are not actually being captured as a result of the operator operating the shutter, and the ADC 108 converts the analog signal to a digital signal and passes the digital signal to the digital signal processing circuit 103. The process described below is then executed using this digital signal to control the timing at which the charge accumulation by the image sensor 102 starts and stops when the operator actually operates the shutter to take a picture.

The rectangular area average luminance calculation unit 109 in the digital signal processing circuit 103 segments the light reception unit of the image sensor 102 into a plurality of areas, and detects which of these multiple areas in the image sensor 102 received the light from which the digital signal was generated. Using the digital signal received from the image sensor 102 via the ADC 108, the average luminance calculation unit 109 then calculates the average luminance in each area based on the luminance signals from each area. The calculated average luminance values are then passed to the image sensor control unit 104.

Based on the average luminance values received from the digital signal processing circuit 103, the image sensor control unit 104 controls the timing for starting and stopping charge accumulation in each of the foregoing areas of the image sensor 102, that is, controls the charge accumulation time (exposure time) in each area of the image sensor 102.

How the image sensor control unit 104 controls the charge accumulation time of the image sensor 102 is described next.

If the average luminance value in a particular area is greater than or equal to a specific threshold value, the image sensor control unit 104 controls the charge accumulation time in that area so that the exposure is shortened. Conversely, if the average luminance value in a particular area is less than or equal to another specific threshold value, the image sensor control unit 104 controls the charge accumulation time in that area so that the exposure is increased. This prevents overexposure and washed-out whites in areas exposed to abundant light, and prevents underexposure and loss of shading in dark areas where there is not enough light.

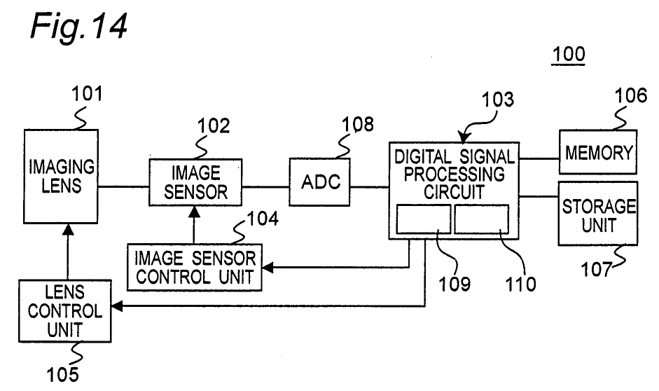

The digital signal processing circuit 103 operates in the present embodiment of the invention to control the image sensor 102 based on detected image brightness, but the invention shall not be so limited. More particularly, the digital signal processing circuit 103 could control the image sensor control unit 104 to change the charge accumulation time of the image sensor 102 between the area where the lens is focused (the focal area) and the area where the lens is not focused (the unfocused area). A focal area detection unit 110 (see an imaging apparatus 100b in FIG. 14) in the digital signal processing circuit 103 could handle identifying the focal area and the unfocused area, that is, evaluating the focusing condition.

The image sensor control unit 104 could also control the charge accumulation time of the image sensor 102 by combining the control based on image brightness and the control based on the focusing condition.

These areas in the light reception unit of the image sensor 102 are determined according to the arrangement of the image sensor 102 as more fully described below.

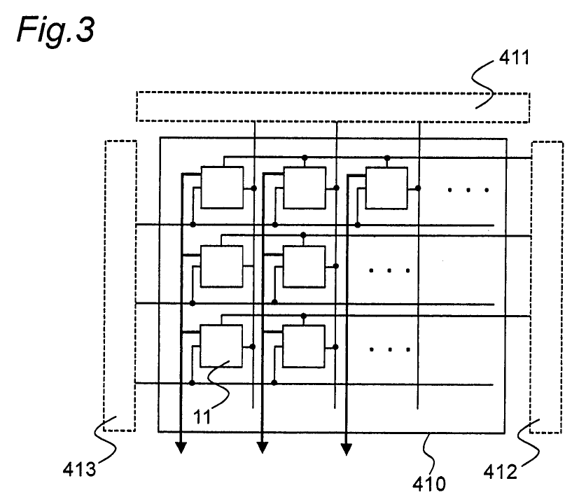

The arrangement of the MOS image sensor 102, and controlling the charge accumulation time in each area of the light reception unit of the image sensor 102, are described more fully below with reference to FIGS. 3, 4, 5, 6, and 7A and 7B.

FIG. 3 shows the arrangement of the MOS image sensor 102. This MOS image sensor 102 has a light reception unit 410 in the middle, and a line selection register 411, column selection register 412, and reset control register 413 connected to the light reception unit 410. A specific number of pixels 11 are arranged along the length and height of the light reception unit 410, which is shown as a large rectangle in the middle. A photodiode and amplifier are disposed to each pixel 11.

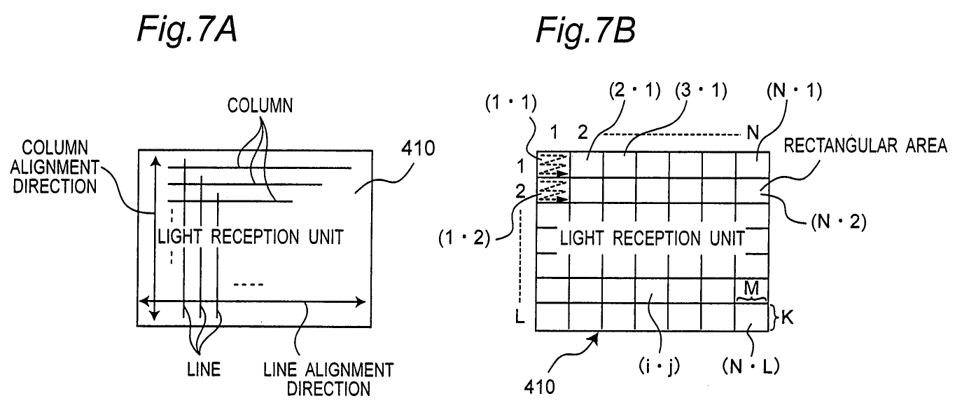

FIG. 7A is a diagram of the light reception unit 410. As shown in FIG. 7A, in this description, a “column” indicates a row of pixels aligned horizontally. The “column” is also referred to as an “h-line”, wherein “h” represents “horizontal”. And the vertical direction of the light reception unit 410 is referred to as a “column alignment direction”. Meanwhile, a “line” indicates a row of pixels aligned vertically. The “line” is also referred to as a “v-line”, wherein “v” represents “vertical”. And the horizontal direction of the light reception unit 410 is referred to as a “line alignment direction”.

As shown in FIG. 7B, each of the foregoing “areas” into which the light reception unit 410 is segmented is a rectangular area M pixels wide (long) and K pixels high. The light reception unit 410 is segmented into N areas wide (long) and L areas high. The total number of areas is thus N×L, and each area contains M×K pixels. These areas are referred to below as the “rectangular areas” in the light reception unit 410. FIG. 7B illustrates the arrangement of these rectangular areas.

FIG. 7A shows the light reception unit 410 of this image sensor 102, which thus measures M×N pixels wide and K×L pixels tall and therefore contains (M×N)×(K×L) pixels.

As noted above, each rectangular area in this light reception unit 410 is M pixels wide and K pixels tall, and the light reception unit 410 is segmented into N areas wide and L areas tall with no gaps therebetween.

As further described below, these values M, N, K, and L are determined by the specific configuration of the MOS image sensor 102.

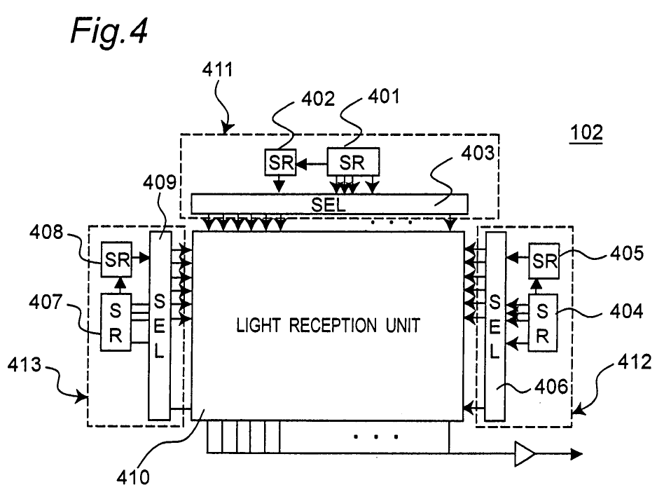

As shown in FIG. 4, the line selection register 411 has two shift registers (SR) 401, 402 and one selector (SEL) 403; the column selection register 412 also has two shift registers 404, 405 and one selector 406; and the reset control register 413 has two shift registers 407, 408 and one selector 409.

These shift registers 401, 402, 404, 405, 407, 408 and selectors 403, 406, 409 are further described below.

Shift registers 401, 402, 404, 405, 407, 408 can be divided into two types.

Shift registers 401, 404 and 407 are the first type of shift register, and are used for pixel shifting. The outputs of the pixel-shifting shift registers 401, 404 and 407 are connected to the corresponding selectors 403, 406, and 409.

Pixel-shifting shift register 401 used as an output timing control unit is part of the line selection register 411, which is used to read the charges accumulated in the pixels. This pixel-shifting shift register 401 is an M-stage shift register for shifting pixels by distance M, that is, the number of pixels aligned along the line alignment position in one rectangular area. Thus pixel-shifting shift register 401 can be smaller than a shift register used for shifting the pixels in all lines of the light reception unit, that is, an M×N stage shift register. This pixel-shifting shift register 401 operates according to the clock signal supplied from the image sensor control unit 104.

Pixel-shifting shift register 404 used as an output timing control unit and pixel-shifting shift register 407 used as a start timing control unit are similarly K-stage shift registers for shifting pixels by distance K, that is, the number of pixels aligned along the column alignment direction in one rectangular area.

Pixel-shifting shift register 404 is part of column selection register 412, which is used to read the charges accumulated in the pixels. Pixel-shifting shift register 407 is part of the reset control register 413, which is used to reset the charges accumulated in the pixels. These pixel-shifting shift registers 404 and 407 likewise operate according to a clock signal supplied from the image sensor control unit 104.

Also similarly to the pixel-shifting shift register 401, these shift registers can be smaller than a shift register used for shifting the pixels in all columns of the light reception unit, that is, smaller than a (K×L)-stage shift register.

Shift registers 402, 405 and 408 are the second type of shift register, and are used for rectangular area shifting. The outputs of the rectangular-area-shifting shift registers 402, 405 and 408 are connected to the corresponding selectors 403, 406, and 409.

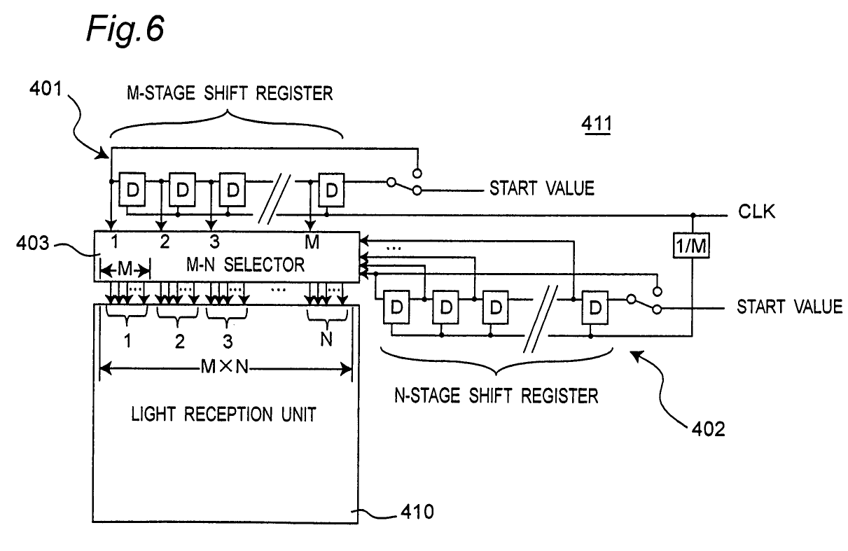

Rectangular-area-shifting shift register 402 used as an area identification unit is an N-stage shift register that is part of the line selection register 411 and is used for counting the rectangular areas in the lengthwise direction. This shift register 402 is also smaller than an (M×N)-shift register sized to the total number of lines of the light reception unit. This rectangular-area-shifting shift register 402 shifts when the pixel-shifting shift register 401 has shifted one cycle or more. As shown in FIG. 6, the period of the clock signal applied to the rectangular-area-shifting shift register 402 is (M×K)-times the period of the clock signal applied to the pixel-shifting shift register 401. A ratio of the period of the clock signal applied to the rectangular-area-shifting shift register 402 to the period of the clock signal applied to the pixel-shifting shift register 401 may be set in consideration of the arrangement of the rectangular area of the light reception unit 410.

Even when combined, the pixel-shifting shift register 401 and rectangular-area-shifting shift register 402 are smaller than a single shift register with (M×N) stages.

Rectangular-area-shifting shift registers 405 and 408 are similarly L-stage shift registers for shifting pixels a distance equal to the height (number) of columns in one rectangular area. The number of the stage is equal to the number of rectangular areas in the column alignment direction, that is, L. The rectangular-area-shifting registers 405 and 408 are used as an area identification unit.

Rectangular-area-shifting shift register 405 is part of the column selection register 412 used for reading the pixel charges. Rectangular-area-shifting shift register 408 is part of the reset control register 413 for resetting the charges accumulated in the pixels. These rectangular-area-shifting shift registers 405 and 408 also shift when the corresponding pixel-shifting shift registers 404 and 407 shift greater than or equal to one cycle. The period of the clock signal applied to the rectangular-area-shifting shift register 405 or 408 is N-times the period of the clock signal applied to the rectangular-area-shifting shift register 402, for example. A ratio of the period of the clock signal applied to the rectangular-area-shifting shift registers 405 and 408 to the period of the clock signal applied to the rectangular-area-shifting shift register 402 may be set in consideration of the arrangement of the rectangular area of the light reception unit 410.

Also similarly to the rectangular-area-shifting shift register 402, these shift registers 405 and 408 can be smaller than a shift register used to shift the pixels in all columns of the light reception unit, that is, smaller than a (K×L)-stage shift register.

Even when combined, the pixel-shifting shift register 404 or 407 and rectangular-area-shifting shift register 405 or 408 are smaller than a single shift register with (K×L) stages.

The selectors (SEL) 403, 406, and 409 are described next.

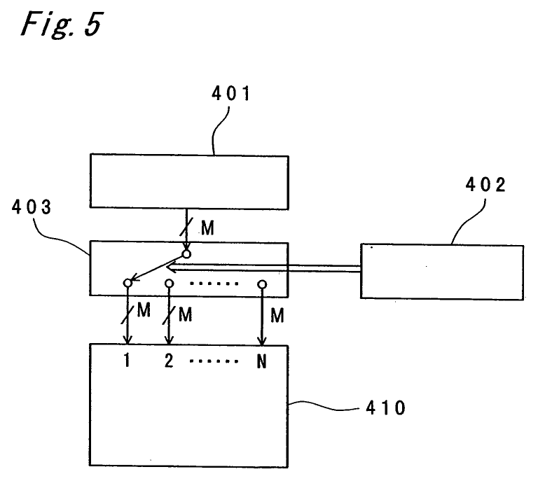

As shown in FIG. 5 and FIG. 6, selector 403, which functions as an output timing control unit, takes the output from the rectangular-area-shifting shift register 402 and pixel-shifting shift register 401, and based on the output from the rectangular-area-shifting shift register 402 determines for which pixel in the line alignment direction of the light reception unit 410 to output the output of the pixel-shifting shift register 401.

As shown in FIG. 6, the selector 403 used as an output timing control unit has (M×N) outputs, and each output is connected to the wiring line connected to the pixels in the same line of the light reception unit 410 (that is, pixels at the same horizontal coordinate of the light reception unit 410).

As shown in FIG. 5 and FIG. 6, based on the output from the rectangular-area-shifting shift register 402, the selector 403 determines the rectangular area in the line alignment direction of the light reception unit 410 to which the output of the pixel-shifting shift register 401 is to be output. That is, if the shift increment of the pixel-shifting shift register 401 is i (where i is an integer from 1 to M) and the shift increment of the shift register 402 is j (where j is an integer from 1 to N), the selector 403 outputs the signal to the (M×(j-1)+i)-th output, that is, the (M×(j-1)+i)-th output terminal from the left.

For example, if the shift increment of the pixel-shifting shift register 401 is 4 (4≦M), and the shift increment of the shift register 402 at this time is 9 (9≦N), the selector 403 outputs the control signal to the output terminal connected to the pixels in the (M×8+4)-th line.

Thus comprised, as shown schematically in FIG. 5, the selector 403 switches the output of the pixel-shifting shift register 401, which can shift the number of pixels of one rectangular area, based on the output from shift register 402. As a result, all pixels in the lengthwise direction (line alignment direction) of the light reception unit 410 of the image sensor 102 can be controlled line by line.

The column selection register likewise has a K-stage pixel-shifting shift register 404, an L-stage rectangular-area-shifting shift register 405, and a selector 406 used as an output timing control unit having (K×L) output terminals, and the reset control register has a K-stage pixel-shifting shift register 407, an L-stage rectangular-area-shifting shift register 408, and a selector 409 used as a start timing control unit having (K×L) output terminals.

The line selection register 411 is described in further detail next with reference to FIG. 6.

As described above, the pixel-shifting shift register 401 is an M-stage shift register, and the rectangular-area-shifting shift register 402 is an N-stage shift register. Both shift registers 401 and 402 output to the selector 403.

Selector 403 has (M×N) output terminals, and each of the output terminals is connected to the pixels on each line of the light reception unit 410 (that is, each one of the out-put terminals is connected to the pixels on the same line). Both shift registers 401 and 402 are connected to the image sensor control unit 104, and the clock signals CLK output from the image sensor control unit 104 are applied to the shift registers. Note that the period of the clock signal applied to the rectangular-area-shifting shift register 402 differs from the period of the clock signal applied to the pixel-shifting shift register 401 so that, the clock signal is applied to the shift register 402 each time the pixel-shifting shift register 401 shifts one cycle or more. The clock signal to the rectangular-area-shifting shift register 402 may be applied each time the pixel-shifting shift register 401 shifts K cycles, for example.

The column selection register 412 and reset control register 413 are basically identical to the line selection register 411, differing in the number of stages in the respective shift registers. Further description thereof is thus omitted.

The shift registers 402, 405, 408 thus function as area identification unit for selecting rectangular areas.

Shift register 407 and selector 409 function as start timing control unit for starting capturing a new image.

Shift registers 401, 404 and selectors 403, 406 function as output timing control unit for outputting the accumulated charges.

A mechanism for sending a control signal to the pixels in each line of the light reception unit 410 using the pixel-shifting shift register 401, rectangular-area-shifting shift register 402, and selector 403 is described next.

For example, when a clock signal is first input from the image sensor control unit 104 to the pixel-shifting shift register 401, wherein the clock signal is used as a second signal, the first stage outputs HIGH and the other stages output LOW. Each time a clock signal is applied from the image sensor control unit 104, the pixel-shifting shift register 401 shifts the stage that outputs HIGH one stage, and the selector 403 outputs a control signal shifting the output terminal that outputs the control signal one terminal to the right. When the pixel-shifting shift register 401 has shifted one complete cycle or more, for example the pixel-shifting shift register 401 has shifted K complete cycles, that is, the clock signal has been output (K×M) times, a clock signal is also applied to the rectangular-area-shifting shift register 402, and the HIGH output from the rectangular-area-shifting shift register 402 shifts one stage. When the rectangular-area-shifting shift register 402 shifts one stage, the shift increment of the pixel-shifting shift register 401 has completed one cycle and returns to the beginning of a cycle, but the selector 403 shifts the output terminal from which the selector 403 outputs the control signal one output-terminal to the right, and thus outputs the control signal to line M+1.

The output terminals of the selector 403 are thus managed in N groups of M output terminals. Input from the rectangular-area-shifting shift register 402 changes the group that outputs the control signal, and one output terminal in the group outputs the control signal based on input from the pixel-shifting shift register 401. The line selection register 411 thus selectively outputs control signals to all lines contained in the light reception unit 410.

All pixels in the light reception unit 410 can be controlled in combination with the similarly configured column selection register 412 and reset control register 413 To capture the image in one frame, the charge in each pixel is reset, that is, the image sensor control unit 104 sends a first signal for resetting the accumulated charge, and the charge accumulated in each pixel is read at a timing leaving an interval sufficient for charge accumulation, that is, the image sensor control unit 104 sends a second signal for reading the accumulated charge. This time interval is equivalent to the exposure time, and is determined by the image sensor control unit 104 based on information from the digital signal processing circuit 103. The exposure time is controlled by the timing at which the clock signals, namely the first and second signals, are applied to the image sensor 102.

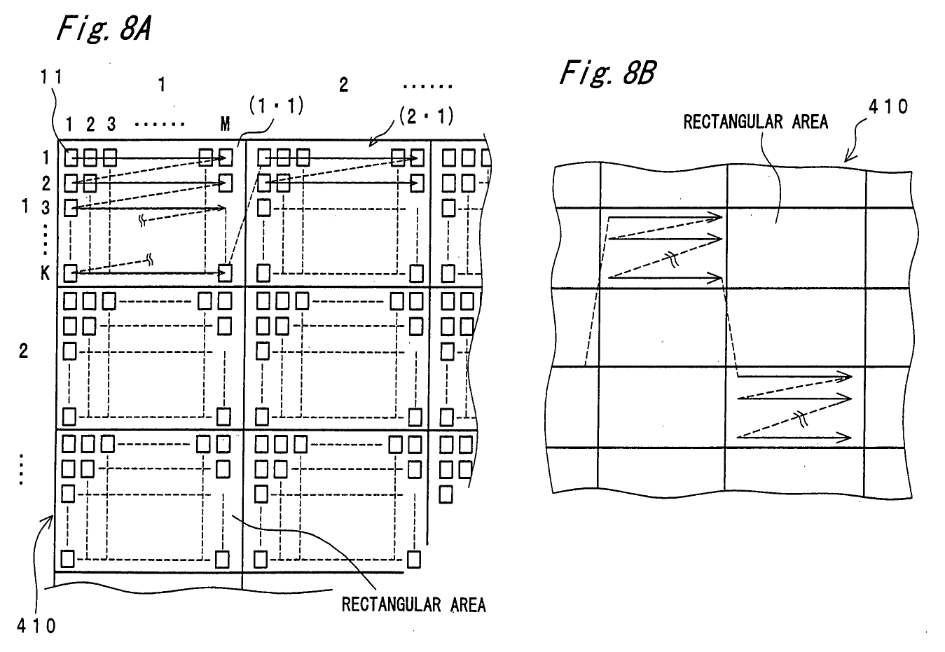

The accumulated pixel charges are read by reading the pixels from each rectangular area in a zigzag pattern from the top left to the bottom right pixel within each rectangular area, and reading the rectangular areas in a zigzag pattern from the top left to the bottom right rectangular area of the light reception unit. This is accomplished by controlling the timing of the clock signals (second signals) input to the line selection register 411 and column selection register 412 so that when pixel-shifting shift register 401 cycles once, pixel-shifting shift register 404 shifts one stage, when pixel-shifting shift register 404 cycles once, rectangular-area-shifting shift register 402 shifts one stage, and when rectangular-area-shifting shift register 402 cycles once, rectangular-area-shifting shift register 405 shifts one stage. As shown in FIG. 7B and FIG. 8A, thus controlling the timing causes reading to start from pixel 11 in the first column position of the first line position in rectangular area (1, 1) (the top and leftmost rectangular area of the light reception unit) and to proceed sequentially in the line alignment direction within the rectangular area. After reaching the end pixel of the first column in the first rectangular area (1, 1), charge reading proceeds from the pixel at first line position in the next column in the same rectangular area (1 1), and continues in this sequence until last pixel in the last column in the same rectangular area (1, 1) has been read as indicated by the dotted lines in FIG. 7B. Reading then steps to the same first pixel 11 in the next rectangular area (2, 1) in the same horizontal position as rectangular area (1, 1). Reading progresses in the same sequence until the last pixel in the last rectangular area (N, 1) in the first row has been read. Reading then steps to the next row and proceeds in the same sequence from rectangular area (1, 2) to (N, 2). This operation continues until the last pixel in the last rectangular area (N, L) is read.

The timing of line selection register 411, column selection register 412, and reset control register 413 operation is controlled by the image sensor control unit 104 controlling the timing of the clock signals output to the image sensor 102, that is the first and second signals, based on the output from the digital signal processing circuit 103 to the image sensor control unit 104.

An imaging apparatus 100a and 100b according to the present invention controls the control timing of the charge accumulation time, for example, individually for each of the multiple rectangular areas as shown in FIG. 7B. As a result, the charge accumulation time in rectangular areas where there is not enough light can be controlled to longer than the charge accumulation time in rectangular areas where light is abundant, thereby avoiding underexposure and loss of gradation in dark areas, and the charge accumulation time in rectangular areas with excessive light can be shortened to prevent overexposure and washed out whites.

An imaging process for changing the control timing in individual rectangular areas is described next.

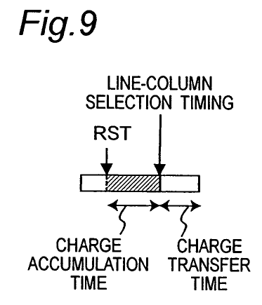

FIG. 9 shows the relationship between the timing of charge accumulation in the pixels of the MOS image sensor 102, and the timing of charge transfer from the pixels. The passage of time is shown on the horizontal axis in FIG. 9. The pixels continue to accumulate a charge as long as the pixels are exposed to light. When a reset timing signal RST (first signal) is applied at a certain timing, that is, when the clock signal is applied to the reset control register 413, the charge accumulated in the photodiode of each pixel is erased and new charge accumulation starts. When a line-column selection timing signal (second signal) is applied, that is, when the clock signal is applied to the line selection register 411 and column selection register 412, the accumulated charge is read via the connected wiring line. The time from the reset timing (RST) to the line-column selection timing thus represents the charge accumulation time, that is, the exposure time. These timings are given by the output from the line selection register 411, column selection register 412, and reset control register 413, each comprising two shift registers (SR) and one selector (SEL) as described with~reference to FIGS. 3 and 4.

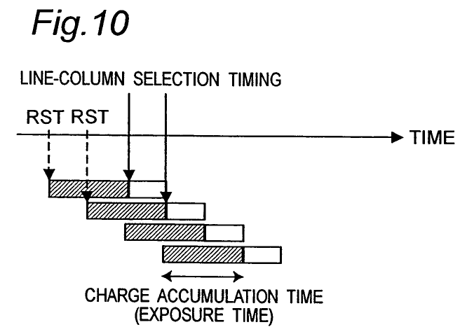

FIG. 10 shows the relationship between the reset timing, line-column selection timing, and a plurality of pixels 11. The reset timing signal RST is applied to each pixel at a constant interval, and the line-column selection timing signal is applied to the pixels at a specific delay after the reset timing signal RST. These signals are applied by shift registers 401, 404, 407 at the same interval in each rectangular area of the light reception unit 410. The pixels in one rectangular area are thus controlled uniformly at the same timing.

To change the charge accumulation time, the reset timing signal RST is temporally shifted before or after the current reference timing. For example, if the interval between the reset timing signal RST and the line-column selection timing signal is shortened, the charge accumulation time becomes shorter and the exposure time is shortened. Conversely, if the timing interval is increased, the charge accumulation time increases and the exposure time increases.

The operating clock of the reset control register 413, which generates the reset timing signal RST, is supplied from the image sensor control unit 104 in this embodiment of the invention. The phase of this operating clock can be changed based on information sent from the digital signal processing circuit 103 to the image sensor control unit 104. The timing at which the reset timing signal RST is output for each rectangular area can thus be changed, and as a result the charge accumulation time can be changed for imaging by each rectangular area.

The reset timing that determines the charge accumulation time for each rectangular area is determined by the digital signal processing circuit 103 based on the image brightness in each rectangular area. More specifically, data (image data) for each captured image passed from the image sensor 102 is digitized by the ADC 108 and the resulting digital image data is input to the digital signal processing circuit 103. Using this digital image data, the average luminance calculation unit 109 in the digital signal processing circuit 103 then generates a luminance signal for each area of the same size as the rectangular areas of the sensor, and calculates the average of the luminance signals in each rectangular area, that is, calculates the average luminance in each rectangular area. The digital signal processing circuit 103 outputs data identifying the rectangular areas and the average luminance data of each rectangular area to the image sensor control unit 104.

If the average luminance of a particular rectangular area is less than or equal to a specific threshold value, the image sensor control unit 104 changes the phase of the operating clock in order to shift the phase of the reset timing signal applied to the image sensor 102 and increase the charge accumulation time. A negative phase shift regarding to time is thus applied to the timing of the reset timing signal RST. Conversely, if the average luminance is greater than or equal to a specific threshold value, the phase is shifted so that the charge accumulation time becomes shorter. That is, a positive phase shift regarding to time is applied to the timing of the reset timing signal RST.

Thus changing the charge accumulation time in each rectangular area based on the image brightness increases exposure in rectangular areas that tend to underexposure with a loss of gradation (that is, in those rectangular areas where the average luminance value is less than or equal to the threshold value), and decreases exposure in rectangular areas that tend to overexposure and washed out whites (that is, in those rectangular areas where the average luminance value is greater than or equal to the threshold value or another threshold value). As a result, both underexposure in dark areas and overexposure in bright areas can be effectively suppressed, and the dynamic ranges of the imaging apparatuses 100a and 100b are improved.

It will be obvious that the same effect can be achieved by changing the phase of the line-column selection timing signal in each rectangular area instead of changing the phase of the reset timing signal. It will also be obvious to one with ordinary skill in the related art that what is important is controlling the charge accumulation time to an appropriate time interval.

How the average luminance calculation unit 109 of the digital signal processing circuit 103 calculates the average luminance value in each rectangular area is described next.

Each rectangular area shown in FIG. 7B contains (M×K) pixels. The pixels in each rectangular area include red pixels R, green pixels G, and blue pixels B. Each group of three pixels including one red pixel R, one green pixel G, and one blue pixel B, constitutes one pixel cell. If the output from the red pixel R is VR, the output from the green pixel G is VG, and the output from the blue pixel B is VB, the luminance Y of each pixel cell is defined as:
Y=0.299VR+0.587VG+0.114VB.

The average luminance value Yave is calculated from the luminance Y of each pixel cell using the following equation:

$${Y}_{ave} = \frac{1}{S} {\sum }_{S}^{} {Y}_{i}$$

where S=M×K/3, and Σ denotes the sum of the luminance of all pixel cells in the rectangular area. Here, for simplicity, we assume that each rectangular area includes the same number of pixels for red pixels, green pixels, and blue pixels. We can also obtain the average luminance value Yave of the rectangular area which may take other pixel arrangement than that mentioned above. Further, we can also calculate the average luminance value of the rectangular area when the image sensor includes one or more pixels for complementary colors.

Based on the average luminance value Yave thus calculated for each rectangular area, the image sensor control unit 104 determines the phase shift of the reset timing signal for each rectangular area.

As shown in FIG. 7B, each rectangular area is identified by the coordinates (i, j) where i is an integer from 1 to N, and j is an integer from 1 to L. The average luminance value Yave of each rectangular area is denoted Yave (i, j).

The process whereby the image sensor control unit 104 determines the phase shift of the reset timing signal for each rectangular area based on the average luminance values received from the digital signal processing circuit 103 is described next.

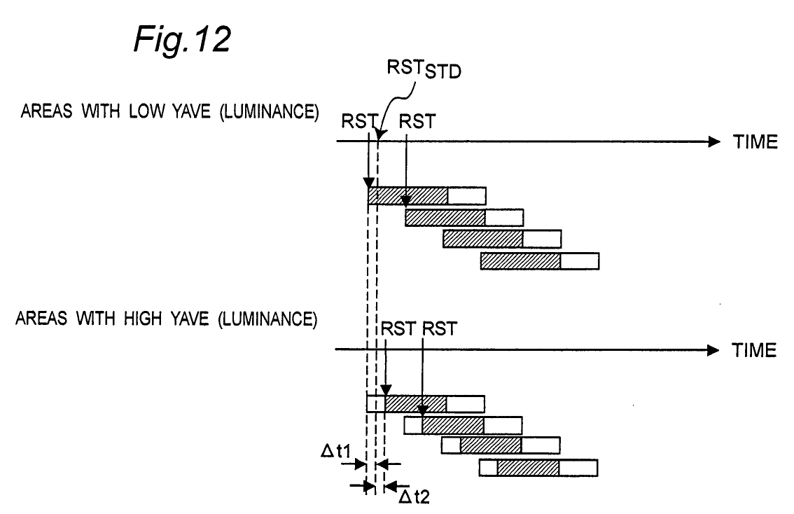

As shown in FIG. 12, the image sensor control unit 104 determines if the average luminance value Yave of rectangular area (1, 1) is less than or equal to a first threshold value. If Yave (1, 1) is less than or equal to the first threshold value, the image sensor control unit 104 shifts the reset timing signal of rectangular area (1, 1) Δt1 negatively temporally, and thus controls driving the reset control register 413. If Yave (1, 1) is not less than or equal to the first threshold value, the image sensor control unit 104 determines if Yave (1, 1) is greater than or equal to a second threshold value. If Yave (1, 1 ) is greater than or equal to the second threshold value, the image sensor control unit 104 shifts the reset timing of rectangular area (1, 1) Δ2 positively temporally, and thus controls driving the reset control register 413. The value of these first and second threshold values is not specifically limited, and these threshold values could be the same.

Furthermore, if average luminance value Yave (1, 1) is greater than the first threshold value and less than the second threshold value, the reset control register 413 is driven at the standard reset timing RSTSTD. The standard reset timing and the line-column selection timing are set automatically in each image using a known method.

The first threshold value is the average luminance at which underexposure becomes a problem. The second threshold value is the average luminance at which overexposure becomes a problem. The first and second threshold values are set according to the characteristics of the image sensor 102. This improves both exposure in both underexposure and overexposure conditions in the rectangular area.

Additional threshold values could be provided in addition to these first and second values for greater gradational control. In this case, the phase shift in the reset timing is preferably changed in stages when the image brightness (average luminance value) is between these additional threshold values.

It will also be obvious that these phase shift values Δt1 and Δt2 could be applied to the line-column selection timing signal to change the phase of the line-column selection timing signal with the same effect.

The remaining rectangular areas are then processed sequentially (2, 1), (3, 1), . . . (N, 1), after which rectangular area (1, 2) is similarly processed. This operation continues until rectangular area (N, L) is processed. The charge accumulated in each pixel in each rectangular area is then read as described above, and capturing the image in one frame ends.

Thus changing the charge accumulation time in each rectangular area to capture the image in one image frame dramatically improves the dynamic range of the imaging apparatus 100a and 100b. This also produces a luminance difference at the boundaries between the rectangular areas because of the difference in the charge accumulation time in each rectangular area. This can result in an unnatural appearance in the image of one frame. An imaging apparatus 100a and 100b according to the present invention therefore applies a correction process to the image data thus stored in memory 106 to achieve a more natural image.

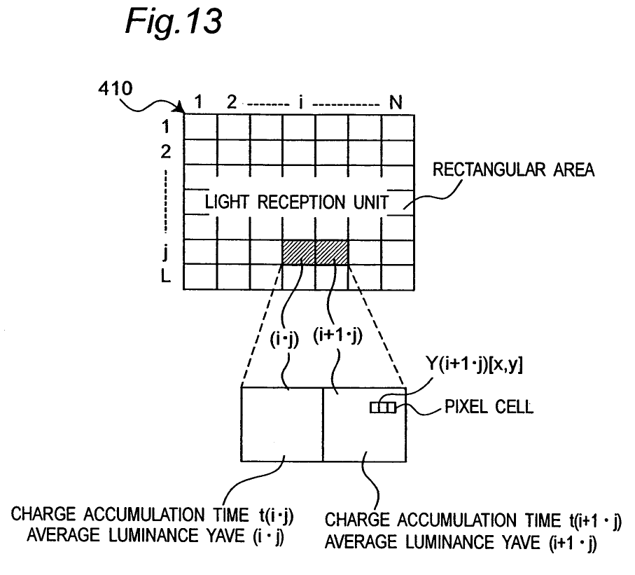

This image data correction process is described next below with reference to FIG. 13. The following variables are used in this correction process.

Y(i,j)[x,y]: the luminance of pixel cell [x, y] in rectangular area (i, j) where i and j are integers, 1≦i≦N, and 1≦j≦L, and [x,y] are coordinates denoting the x-th in the line alignment direction and y-th in the column alignment direction pixel cell in the area (i, j). Each pixel cell is a group of adjacent pixels including one red pixel R, one green pixel G, and one blue pixel B.

Yave(i,j): the average luminance value of rectangular area (i, j).

t(i,j): the charge accumulation time of rectangular area (i, j), which is the same as the time interval between the reset timing and line-column selection timing of the rectangular area.

tSTD: standard charge accumulation time. This is time interval between the standard reset timing and the line-column selection timing.

This image data correction process starts from rectangular area (1, 1) and proceeds sequentially to determine the change in the luminance value of each pixel cell based on the difference between the average luminance in one rectangular area and the average luminance in the next adjacent rectangular area on the same row. The correction process is thus applied sequentially to rectangular areas (1, 1), (2, 1), . . . ((N-1), 1), and rectangular area (N, 1) is corrected based on the difference in the average luminance in area (N, 1) and area ((N-1), 1). Correction then continues from the first area in the new row, that is, (1, 2), (2, 2), . . . ((N-1), 2), (N, 2), and so forth to determine the change in the luminance value of each pixel cell in each rectangular area.

When this correction process is completed through rectangular area (N, L), operation returns to rectangular area (1, 1) to determine the change in the luminance of each pixel cell based on the difference in the average luminance of vertically adjacent rectangular areas from area (1, 1) to area (N, L).

The luminance data of each pixel cell is then changed based on the values obtained from above process. The final determination of this change in pixel cell luminance results from applying a statistical operation, such as averaging, to the values of the changes determined by comparing the luminance data in horizontally adjacent rectangular areas and comparing the luminance data in vertically adjacent rectangular areas.

This correction process is described more specifically below. The correction process described by way of example below is based on comparing the luminance of one rectangular area and the luminance of the rectangular area adjacent thereto on the right side.

In this example, the change in the luminance data of the pixel cells contained in rectangular area (i, j) is determined by comparison with the average luminance of area (i+1, j).

The change in the luminance data is determined conditionally according to the four methods described below based on the relationship between the three quantities t (i, j), t (i+1, j), and tSTD.
If t(i,j)≠t(i+1,j), and t(i,j)=tSTD (1)

If the charge accumulation time of the target rectangular area (that is, the rectangular area for which the luminance change is being determined) differs from the charge accumulation time of the right adjacent rectangular area, and the charge accumulation time of the target rectangular area is the standard charge accumulation time, the luminance change is
Yave(i,j)−Yave(i+1,j),
that is, the average luminance of the target rectangular area minus the average luminance of the right adjacent rectangular area.
If t(i,j)≠t(i+1,j), and t(i+1,j)=tSTD (2)

If the charge accumulation time of the target rectangular area differs from the charge accumulation time of the right adjacent rectangular area, and the charge accumulation time of the right adjacent rectangular area is the standard charge accumulation time, the luminance change is
Yave(i+1,j)−Yave(i,j),
that is, the average luminance of the right adjacent rectangular area minus the average luminance of the target rectangular area.
If t(i,j)≠t(i+1,j), t(i,j)≠tSTD, and t(i+1,j)≠tSTD (3)

If the charge accumulation time of the target rectangular area differs from the charge accumulation time of the right adjacent rectangular area, and the charge accumulation time of the target rectangular area and the charge accumulation time of the right adjacent rectangular area both differ from the standard charge accumulation time, the luminance change is
(Yave(i,j)−Yave(i+1,j))/2,
that is, the difference of the average luminance of the target rectangular area minus the average luminance of the right adjacent rectangular area, divided by two.

This case applies when the charge accumulation time of one rectangular area is shorted than the standard charge accumulation time, and the charge accumulation time of the other rectangular area is longer than the standard charge accumulation time. As a result, the change is half the difference between the two average luminance values.
If t(i,j)=t(i+1,j) (4)

If the charge accumulation time of the target rectangular area equals the charge accumulation time of the right adjacent rectangular area, the luminance value is not changed. This is because there is no difference in luminance at the border between the two areas.

The luminance change in vertically adjacent rectangular areas can be determined using this same method.

Based on the luminance change thus determined, the values are statistically processed in each rectangular area to, for example, obtain the average, thereby determine the correction to be applied to the luminance data in each pixel cell, and thus correct the image data. The difference in luminance between adjacent rectangular areas is thus improved, a more natural appearance is imparted to the image, arid an image with an improved dynamic range is simultaneously achieved.

The amount of correction applied within a rectangular area could increase with proximity to the border of the rectangular area so that the correction results in a smoother connection between adjacent rectangular areas.

As described above, the digital signal processing circuit 103 in this embodiment of the invention changes the reset timing based on luminance information. As shown in FIG. 14, however, different reset timing could be applied to the area containing the focal point and to the other areas not containing the focal point, using the focal area detection unit 110 of the digital signal processing circuit 103 of the imaging apparatus 100b. More specifically, the charge accumulation time can be changed based on the relationship between the distance to the subject contained in each rectangular area and the focal distance of the imaging apparatus 100b. In flash photography, for example, the charge accumulation time is shortened in the area where the lens is focused because the strobe is driven to illuminate this area, and the charge accumulation time is increased in the surrounding background areas. In this case the reset timing can be set uniformly to a previously adjusted timing for synchronization with a strobe driven timing.

The reset timing could also be changed in areas where the subject is moving. Detecting where there is movement and shortening the charge accumulation time in those areas enables the subject to be imaged without blurring.

Segmenting the sensor area (light reception unit 410) into a plurality of rectangular areas and uniformly controlling exposure within each rectangular area enables independently controlling the charge accumulation time in each rectangular area without a great increase in the circuit scale. By assuring a longer charge accumulation time in dark areas and a shorter charge accumulation time in bright image areas, an image can be captured using different exposure times in different parts of the total imaging area of the sensor (light reception unit 410). As a result, images can be captured with a wider dynamic range.

The image sensor 102 outputs charges accumulated in the pixels by the unit of one rectangular area. Thus designed, the digital signal processing circuit 103 provided with a line memory having a certain amount of capacity which is equal to the product of the number of horizontal pixels (the number of pixels in line alignment direction) and the number of vertical pixels (the number of pixels in column alignment direction) in one rectangular area can process a two-dimensional filtering to digital signals such as when carrying out a preprocessing of the digital signals. Therefore, the line memory can be configured with a relatively small size memory capacity.

### Embodiment 2

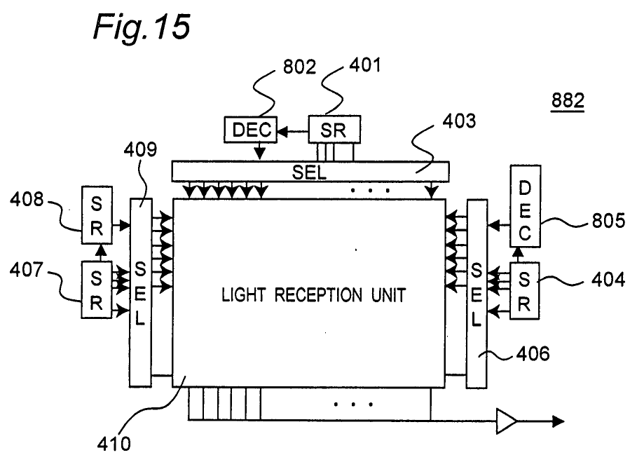

FIG. 15 shows the arrangement of an image sensor 882, according to a second embodiment of the present invention, for use in the imaging apparatus 100a and 100b. This image sensor 882 differs from the image sensor 102 of the foregoing first embodiment in that shift registers 402, 405 shown in FIG. 4 and FIG. 6 are replaced by decoders (DEC) 802 and 805. These decoders 802 and 805 decode rectangular area identification information sent from the image sensor control unit 104 to identify a particular rectangular area. In addition to the outputs described before, the image sensor control unit 104 in this embodiment of the invention therefore also outputs this rectangular area identification information to the decoders 802 and 805.

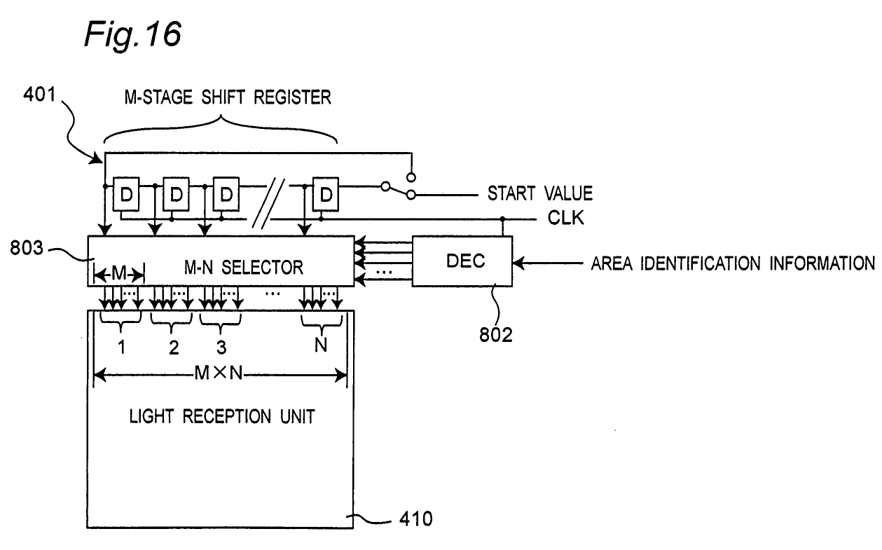

Operation of these decoders 802 and 805 is described next with reference to FIG. 16.

When capturing an image, the digital signal processing circuit 103 calculates the average luminance of each rectangular area and sends the average luminance values to the image sensor control unit 104. The charge elimination and reading progress sequentially from the rectangular area with the shortest charge accumulation time. Thus, the digital signal processing circuit 103 sends the rectangular area identification information alone or together with the rectangular area luminance information and control clock signal information to the image sensor control unit 104, in the order sequentially from the rectangular area with the shortest charge accumulation time. Accordingly, a particular rectangular area can be identified by the image sensor control unit 104.

After receiving the rectangular area identification information, luminance information, and control clock signal information, the image sensor control unit 104 sends the rectangular area identification information and clock signal to the decoders 802 and 805 and shift registers 401, 404, 407, and 408 of the image sensor 882 while controlling the timing based on the received control clock signal information. As in the first embodiment, resetting is controlled by sequentially sending a clock signal to a reset controller composed of two shift registers and one selector.

The rectangular area identification information, which is the third signal of the accompanying claims, is input to the decoders 802 and 805. This rectangular area identification information is a signal encoded by the digital signal processing circuit 103 identifying the rectangular areas. The decoders 802 and 805 decode this signal. Based on the decoded rectangular area identification information, the decoders 802 and 805 determine one output, and output to selectors 403 and 406. Based on this output, the selectors determine which rectangular area to read, determine the pixel to read by means of the input from the pixel-shifting shift registers 401, 404, and output to the 410 to read the pixel charges.

The imaging apparatus 100a or 100b according to the foregoing first embodiment of the invention advances or delays the reset timing for imaging. In this embodiment of the invention, however, the charge accumulation time is changed by controlling the timing of transmission of information related to the selected rectangular area, that is, rectangular area identification information to the decoders 802 and 805 of the line selection register 411 and column selection register 412. As shown in FIG. 8B, although, the charge reading sequence within each rectangular area is the same as in the first embodiment, the sequence in which the rectangular areas are selected and read can be freely selected and changed based on information of the image being captured.

By reading the rectangular areas with a short charge accumulation time first, the overall charge reading time of the image sensor for one image is shortened, and the difference between the charge accumulation start time of the pixel read first and the pixel read last from the image sensor can be reduced. As a result, moving subjects can be imaged with less distortion.

The configuration, control, and correction process in this second embodiment are otherwise identical to the first embodiment.

As described above, segmenting the image sensor (light reception unit 410) into a plurality of rectangular areas and controlling imaging uniformly in each rectangular area enables controlling the charge accumulation time separately in each rectangular area without greatly increasing the circuit scale.

Furthermore, reading the pixels sequentially from the rectangular areas in order from the shortest charge accumulation time effectively suppresses image distortion that is particular to an image sensor designed to change the charge accumulation time by controlling charge elimination and charge output pixel by pixel.

### Embodiment 3

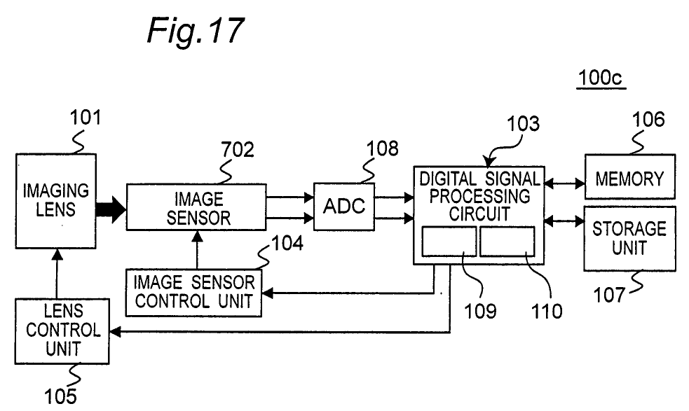

FIG. 17 is a block diagram of an imaging apparatus according to the third embodiment of the present invention. The imaging apparatus 100c is essentially identical to the foregoing imaging apparatuses 100a and 100b according to the first and second embodiments of the present invention. An image sensor 702 has two output channels connected to an ADC 108. The ADC 108 has two output channels connected to a digital signal processing circuit 103. When signals input to the ADC 108 are mixed, the ADC 108 may have only one output channel. In the present embodiment, since the image sensor 702 and ADC 108 have two output channels, information obtained from the imaging at the image sensor 702 can be transmitted faster.

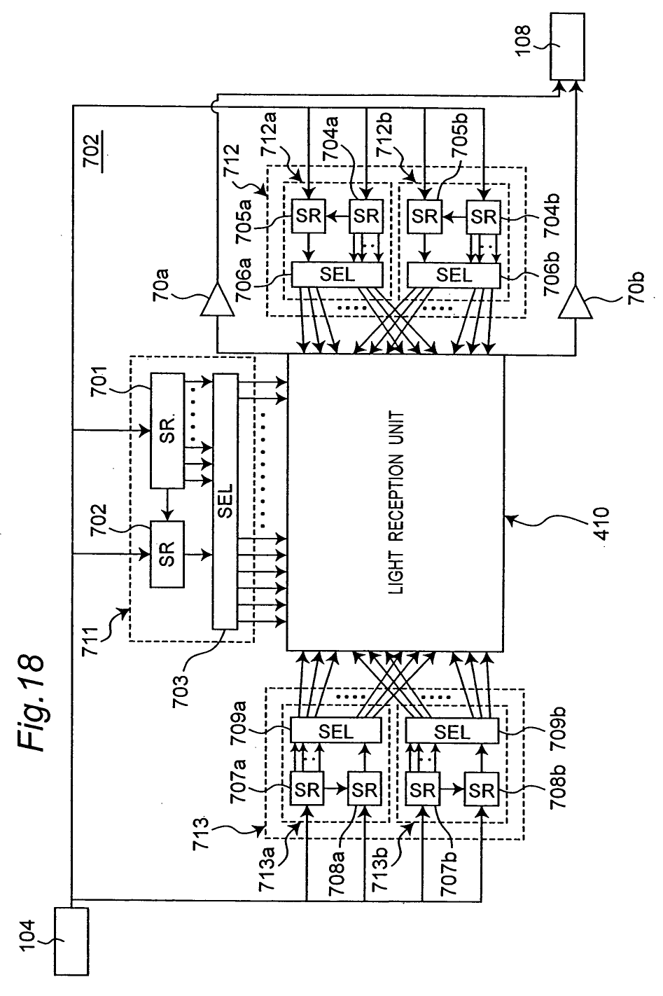

FIG. 18 is a block diagram of the image sensor 702 according to this embodiment. A light reception unit 410 of the image sensor 702 is identical to the light reception unit 410 of the image sensors 102 and 882. The image sensor 702 also has a line selection register 711, a column selection register 712, and a reset control register 713 connected to the light reception unit 410. The line selection register 711 is identical to the line selection register 411 of the image sensor 102. The line selection register 711 has a shift register 702, a shift register 701, and a selector 703. The shift register 702 is used as an area identification unit, and the shift register 701 and the selector 703 are used as first and second output timing control unit, respectively.

The column selection register 712 and the reset control register 713 differ from the corresponding registers of the foregoing first embodiment. The differences are described next.

The column selection register 712 has two column selection units 712a and 712b. The column selection unit 712a has a (K/2)-stage shift register 704a which functions as a first output timing control unit, L-stage shift register 705a which functions as an area identification unit, and a selector 706a which is connected to two shift registers 704a and 705a and functions as a first output timing control unit. The selector 706a has (K×L/2) outputs. These outputs are connected to the wiring lines each connected to the pixels of the same column (the same position in the column alignment direction) of the light reception unit 410. Thus, one output is connected to the pixels aligned at the same vertical position of the light reception unit 410. The column selection unit 712b is identical to the column selection unit 712a. The column selection unit 712b has a (K/2)-stage shit register 704b which functions as a second output timing control unit, L-stage shift register 705b which functions as an area identification unit, and a selector 706b which is connected to two shift registers 704b and 705b and functions as a second output timing control unit. The selector 706b has (K×L/2) outputs. Wiring lines, each connected to the pixels aligned in the same column are connected alternately to the outputs of the selectors 706a and 706b, alternately. More precisely, in this embodiment, the wiring lines connected to the odd columns from the top of the light reception unit 410 are sequentially connected to the outputs of the selector 706a, and the wiring lines connected to the even columns from the top of the light reception unit 410 are sequentially connected to the outputs of the selector 706b. Hereinafter, the pixels in the odd columns are referred to as odd column pixels and the pixels in the even columns are referred to as even column pixels.

Similar to the column selection register 712, the reset control register 713 has two reset control units 713a and 713b. The reset control unit 713a has a (K/2)-stage shift register 707a which functions as a first start timing control unit, L-stage shift register 708a which functions as an area identification unit, and a selector 709a which is connected to two shift registers 707a and 708a and functions as a first start timing control unit. The selector 709a has (K×L/2) outputs. Each of these outputs is connected to the wiring line each connected to the pixels in the same column of the light reception unit 410. The reset control unit 713b is identical to the reset control unit 713a. The reset control unit 713b has a (K/2)-stage shift register 707b which functions as a second start timing control unit, an L-stage shift register 708b which functions as an area identification unit, and a selector 709b which is connected to two shift registers 707b and 708b and functions as a second start timing control unit. The selector 709b has (K×L/2) outputs. Wiring lines, each connected to the pixels aligned in the same column are connected alternately to the outputs of the selectors 709a and 709b. More precisely, in this embodiment, the wiring lines connected to the odd columns from the top of the light reception unit 410, that is, the odd column pixels, are sequentially connected to the outputs of the selector 709a, and the wiring, lines connected to the even columns from the top of the light reception unit 410, that is, the even column pixels, are sequentially connected to the outputs of the selector 709b.

The image sensor 702 of this embodiment has two output channels. A first output channel includes an amplifier 70a. The first output channel outputs the charges accumulated in the pixels which are connected to the column selection unit 712a. A second output channel includes an amplifier 70b. The second output channel outputs the charges accumulated in the pixels which are connected to the column selection unit 712b.

Referring again to FIG. 17, as already mentioned, the image sensor control unit 104 functions as a control unit, which controls the image sensor 102 for imaging. The image sensor control unit 104 controls a charge accumulation time (exposure time) for each rectangular area. As shown in FIG. 18, for each rectangular area, the image sensor control unit 104 controls, based on the information related to average luminance value and the like input from the digital signal processing circuit 103, the line selection register 711, column selection units 712a and 712b, and reset control units 713a and 713b independently from each other.

By the above arrangement, the image sensor 702 can capture an image with two different charge accumulation times (two different exposure times) in each rectangular area. One charge accumulation time is set for reading charges accumulated in the odd column pixels, and the other charge accumulation time is set for reading charges accumulated in the even column pixels. Therefore, the image sensor 702 can capture one image using the odd column pixels of which exposure time is relatively long and the even column pixels of which exposure time is relatively short. The odd column pixels and the even column pixels are alternately aligned on the light reception unit 410. In fact, the pixels charged for a relatively long time and the other pixels charged for a relatively short time are alternately aligned one by one in the column alignment direction (vertical direction). It is difficult for human eyes to cognize the alternating bright and dark lines (columns) which appear one after the other in one pixel pitch. For human eyes, the image can be viewed as a natural image. According to this embodiment, the dynamic range of the imaging apparatus is improved.

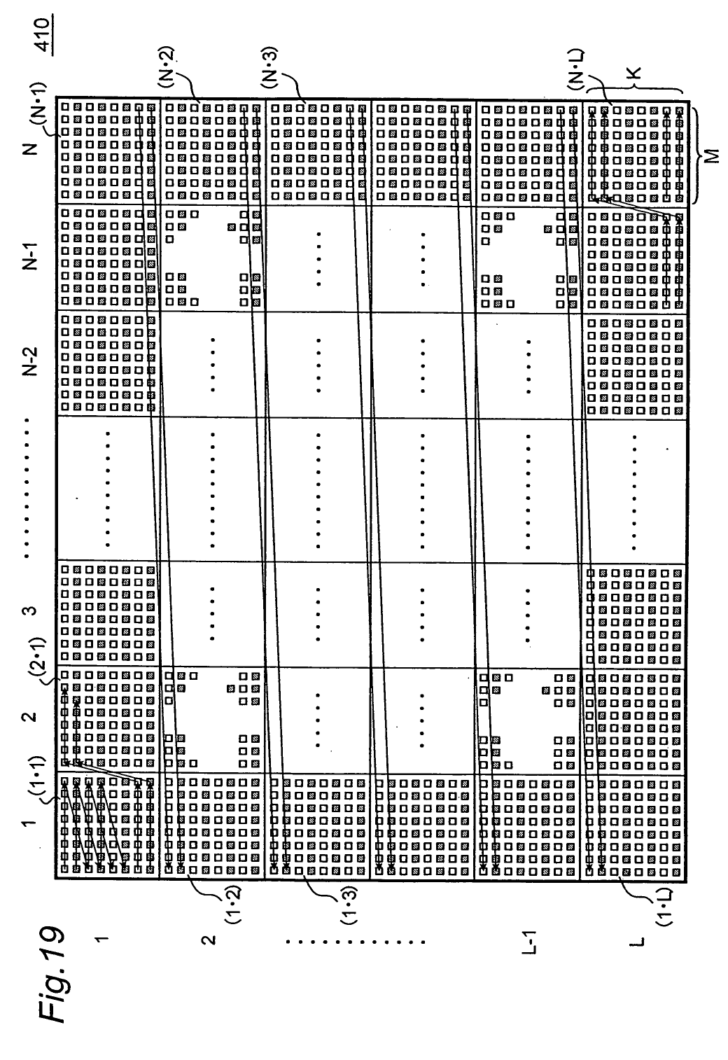

FIG. 19 is a schematic diagram showing a charge reading sequence of the image sensor 702 according to this embodiment. The light reception unit 410 is segmented into (N×L) rectangular areas such that N rectangular areas are aligned in the line alignment direction (lengthwise direction) and L rectangular areas are aligned in the column alignment direction (vertical direction). Each rectangular area has (M×K) pixels. The pixels at odd columns are depicted by white squares, and the pixels at even columns are depicted by hatched squares.

First, the charges accumulated in the odd column pixels in the rectangular area (1, 1) are read sequentially from the top left pixel, that is, the pixels in the first column are read towards right. After reading the charge in the rightmost pixel of the first column in the rectangular area (1, 1), the pixel at the first line position and third column position is read. The read charges are output from the first channel for ADC 108.

Independently of the above mentioned charge reading, the charges accumulated in the even column pixels in the rectangular area (1, 1) are read sequentially from the top left pixel, that is, the pixels in the second column position are read towards right. After reading the charge in the rightmost pixel of the second column position in the rectangular area (1, 1), the pixel at the first line position and fourth column position is read. The read charges are output from the second channel for ADC 108.

The charge readings for pixels in an odd column and the charge readings for pixels in an even column can be done simultaneously. Furthermore, the charge accumulation time (exposure time) of one pixel and that of another pixel can be different from each other, wherein these two pixels are read at about the same timing. This is accomplished by varying the control timing of the reset control unit 713a and that of the reset control unit 713b. It is to be understood that the readings of the charges accumulated in the odd column pixels and the readings of the charges accumulated in the even column pixels do not have to be done at the same timing. In addition, the imaging with varied charge accumulation time (exposure time) between odd column pixels and even column pixels can be done similarly by varying the control timing of the column selection unit 712a and that of the column selection unit 713b. There is no need to synchronize the output timing of the first output channel with that of the second output channel. These two channels may output information related to the read charge for ADC 108 in different timings independently from one another.

After finishing the readings of the accumulated charges in the rectangular area (1, 1), the readings of the accumulated charges in the rectangular area (2, 1) start. As mentioned above, the charge accumulation time of the rectangular area (2, 1) may be varied with that of the rectangular area (1, 1). Moreover, in this embodiment, an amount of the variation of the charge accumulation time between the present rectangular area and the last rectangular area for the odd column pixels can be varied with an amount of the variation between the present rectangular area and the last rectangular area of the charge accumulation time for the even column pixels.

After finishing the charge reading of the rectangular area (N, 1), the charge reading of the rectangular area (1, 2) starts. Similarly, the charge reading progresses to the last rectangular area (N, L). The charge readings for one frame image finish when the charge readings of all the rectangular area (N, L) are completed.

In addition, the charge reading can be culled, for example, by skipping one or more pixels aligned in one odd column or even column or skipping one or more pixels in odd and even columns. As a result, the rate of output of accumulated charges can be changed. This modification is easily accomplished by a person skilled in the art. For example, the shift increment of the shift register 701 of the line selection register 711 can be set every one or more other lines. The imaging with the skip charge reading results in decreasing of a required time for one imaging. This is particularly applicable to suppress the image deformation of a moving object.

The image sensor 702 according to the present embodiment has the column selection register 712 and reset control register 713, each having a plurality of units (712a and 712b and 713a and 713b). It is possible to form each of the line selection register 711 and reset control register 713 with a plurality of units. Furthermore, it is possible to arrange registers 711, 712, and/or 713 to have more than two units, and to arrange the image sensor 702 to have the same number of output channels as the number of units each registers 711, 712, and/or 713 has.

By the above arrangement, the wiring lines required in this embodiment can be made as less as those of the first and second embodiments. Also, the circuit size of the shift registers and selectors of this embodiment can be made as small as those of the first and second embodiments.

Other than the above, the structure, control, and correction process in the third embodiment are the same as those of the first or second embodiment.

### Embodiment 4

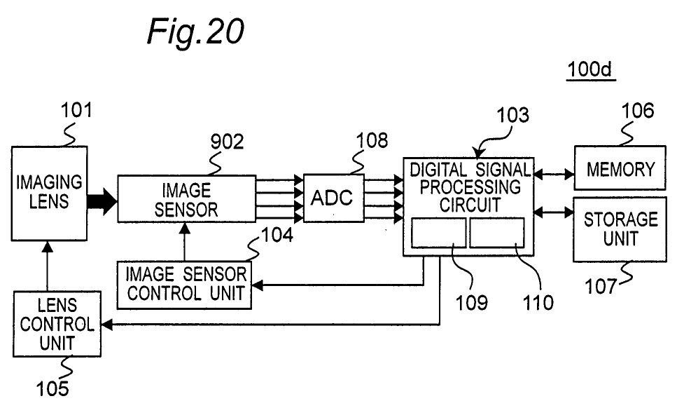

FIG. 20 is a block diagram of an imaging apparatus 100d according to the fourth embodiment. The imaging apparatus 100d is essentially identical to the foregoing imaging apparatuses 100a, 100b, and 100c of the first, second, and third embodiments, except that an image sensor 902 has four output channels. The image sensor 902 and ADC 108 also have four output channels. It is possible to arrange the ADC 108 to have only one output channel, provided that signals input into the ADC 108 are mixed appropriately. By using the four output channels from the image sensor 902, it is possible to increase the speed of data transmission from the image sensor 902 to ADC 108 and further to the digital signal processing circuit 103.

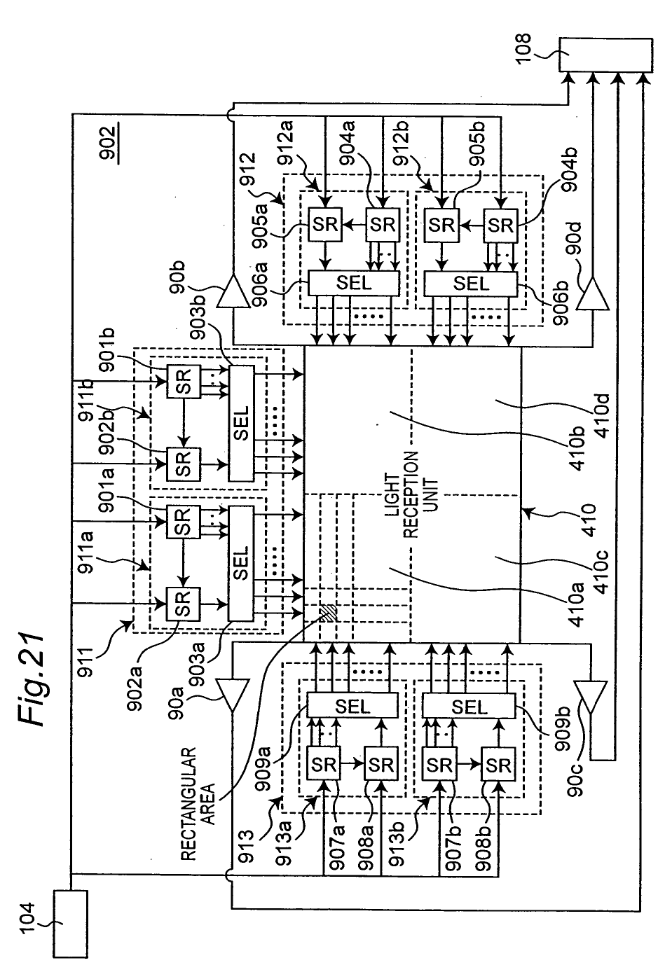

FIG. 21 is schematic diagram of the image sensor 902. The light reception unit 410 of the image sensor 902 is basically identical to the light reception units 410 of the image sensor 102, 882, and 702 except that the plurality of the rectangular areas in the light reception unit 410 of the present embodiment are grouped into P groups, where P is an integer more than one. In this embodiment, the rectangular areas are grouped into four groups, that is, P is 4. These four groups of rectangular areas are referred to as a group 410a, group 410b, group 410c, and group 410d. Each of these groups 410a, 410b, 410c, and 410d has a plurality of rectangular areas. For instance, when the light reception unit 410 has one hundred rectangular areas and these rectangular areas are divided into four groups, each group has twenty five rectangular areas.

Note that the number of the rectangular areas contained in one group may be the same as the number of that contained in other groups, or may be different from the number of that contained in another group.

Furthermore, one group may contain only one rectangular area. Each group 410a, 410b, 410c, or 410d corresponds to one of the four output channels. In other words, rectangular areas are grouped such that charges accumulated in the pixels contained in one group are output from the corresponding output channel. The charges accumulated in the pixels contained in the group 410a are output from the first output channel and input to the ADC 108. Likewise, charges accumulated in the groups 410b, 410c, and 410d are output from the second, third, and fourth output channels, respectively, and are input to the ADC 108.

The image sensor 902 has line selection register 911, column selection register 912, and reset control register 913, which are connected to the light reception unit 710. The line selection register 912 has two line selection units 911a and 911b. The line selection unit 911a has an M-stage shift register 901a which functions as an output timing control unit, an (N/2)-stage shift register 902a which functions as an area identification unit, and a selector 903a which is connected to two shift registers 901a and 902a and functions as an output timing control unit. The selector 903a has (M×N/2) outputs.

Each of these outputs is respectively connected to the wiring line which is commonly connected to pixels in one line (same line position in the lengthwise direction). The line selection unit 911b is configured basically identical with the line selection unit 911a. The shift register 901b is an M-stage shift register, which is used as the output timing control unit. The shift register 902b is an (N/2)-stage shift register, which is used as the area identification unit. The selector 903b has (M×N/2) outputs and is connected to two shift registers 901b and 902b.

As to the groups 410a and 410c, pixels lined in one line (aligned vertically) are commonly connected to one wiring line, which is also connected to one of the outputs of the selector 903a. Likewise, as to the groups 410b and 410d, pixels aligned vertically in one line are commonly connected to one wiring line, which is also connected to one of the outputs of the selector 903b.

The column selection register 912 has two column selection units 912a and 912b. The column selection unit 912a has a K-stage shift register 904a which functions as an output timing control unit, an (L/2)-stage shift register which functions as an area identification unit, and a selector 906a which is connected to the shift registers 904a and 905a and functions as an output timing control unit. The selector 906a has (K×L/2) outputs. These outputs of the selector 906a are connected to the wiring lines each of which is commonly connected to the pixels in one column (same position in the vertical direction). The column selection unit 912b is also configured basically identical with the column selection unit 912a. The shift register 904b is a K-stage shift register, which is used as an output timing control unit. The shift register 905b is an (L/2)-stage shift register, which is used as an area identification unit. The selector 906b has (K×L/2) outputs and is connected to two shift registers 904b and 905b, which is used as an output timing control unit.

As to the groups 410a and 410b of the light reception unit 410, pixels aligned in one column (pixels lined horizontally) are commonly connected, to one wiring line which is also connected to one of the outputs of the selector 906a. Likewise, as to the groups 410c and 410d, pixels aligned horizontally in one column are commonly connected to one wiring line which is also connected to one of the outputs of the selector 906b.

The reset control register 913 also has two reset control units 913a and 913b. The reset control unit 913a has a K-stage shift register 907a which functions as a start timing control unit, an (L/2)-stage shift register 908a which functions as an area identification unit, and a selector 909a which is connected to the shift registers 907a and 908a and functions as a start timing control unit. The selector 909a has (K×L/2) outputs. Each of these outputs is connected to the wiring line to which pixels in one column of the light reception unit 410 are commonly connected. The reset control unit 913b is also configured basically identically with the reset control unit 913a. The shift register 907b is a K-stage shift register, which is used as a start timing control unit. The shift register 908b is an (L/2)-stage shift register, which is used as an area identification unit. The selector 909b used as a start timing control unit, has (K×L/2) outputs and is connected to two shift registers 907b and 908b.

As to the groups 410a and 410b of the light reception unit 410, pixels aligned in lengthwise direction (aligned along the same column position) are commonly connected to one wiring line which is also connected to one of the outputs of the selector 909a. Likewise, as to the groups 410c and 410d, pixels aligned in the lengthwise direction are commonly connected to one wiring line which is also connected to one of the outputs of the selector 909b.

The image sensor 902 according to fourth embodiment has 4 output channels. One of these output channels, for example, a first output channel includes an amplifier 90a. The first output channel outputs charges accumulated in the pixels contained in the first group 410a. The other output channels, that is, a second, a third, and a fourth output channels include amplifiers 90b, 90c, and 90d, respectively and output the charges accumulated in the pixels contained in the second, third, and fourth groups 410b, 410c, and 410d, respectively.

Referring back to FIG. 20, the image sensor control unit 104, which functions as a control unit for imaging by the image sensor 902, controls a charge accumulation time in each rectangular area of the light reception unit 410. In the present embodiment, as shown in FIG. 21, the image sensor control unit 104 controls the line selection units 911a and 911b, column selection units 912a and 912b, and reset control units 913a and 913b independently and individually in each rectangular area based on information such as average luminance value and the like input from the digital signal processing circuit 103.

By the above arrangement, it is not only possible to change the charge accumulation time (exposure time) among rectangular areas, but also to individually control the charge accumulation time and the timing of capturing an image for each of the four groups 410a, 410b, 410c, and 410d. Therefore, the image sensor 902 can capture one image separately at four groups 410a, 410b, 410c, and 410d.

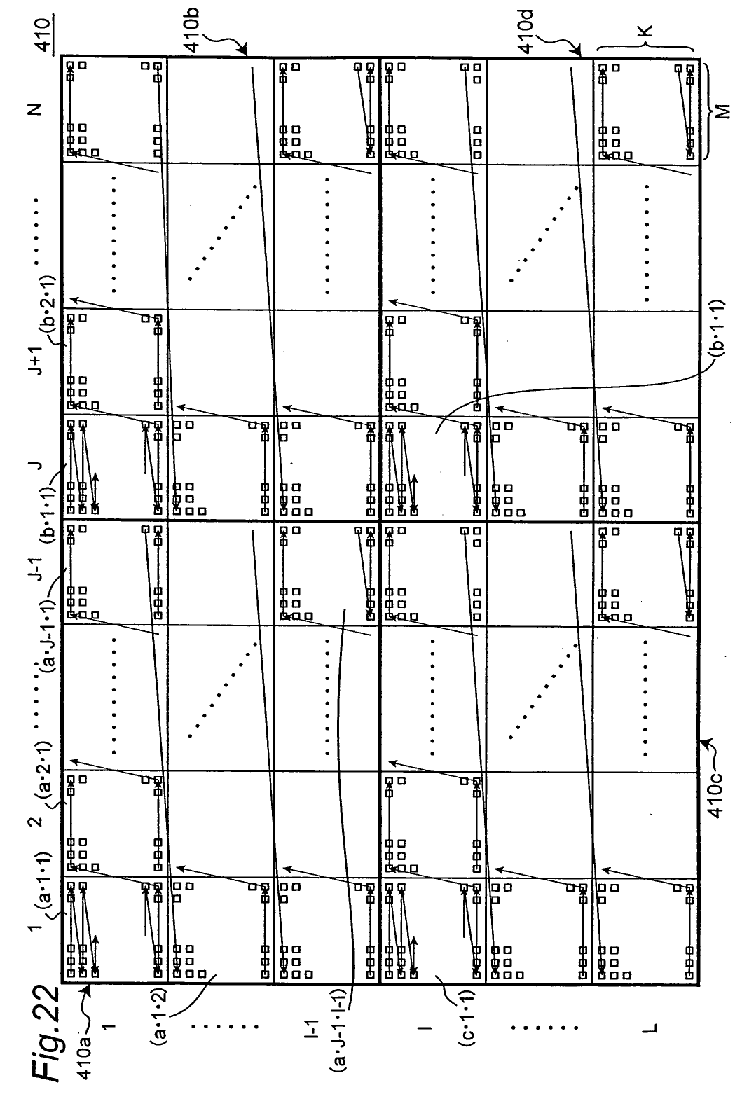

FIG. 22 illustrates a sequence of reading of the accumulated charges in the image sensor 902 according to the present embodiment. The light reception unit 410 has N rectangular areas aligned in the line alignment direction (the lengthwise direction) and L rectangular areas aligned in the column alignment direction (the vertical direction). Each rectangular area has (K×M) pixels. The group 410a has (J-1) rectangular areas aligned in the line alignment direction and (I-1) rectangular areas aligned in the column alignment direction. The group 410a thus contains ((J-1)×(I-1)×(K×M) pixels.

First, a charge accumulated in the first line position of first column position (top left pixel in the Figure) is read and charges are read in order in the same column in the rectangular area (a, 1, 1). After reading of a charge accumulated in the pixel in the rightmost line position of the first column in the rectangular area (a, 1, 1), charges in the pixels in the first line position of the second column position is read. The read charges are output from the first output channel for the ADC 108.

Independently of the above described charge reading for pixels contained in the group 410a, charges accumulated in each pixels of the first line position of the first column position in the rectangular areas (b, 1, 1), (c, 1, 1), and (d, 1, 1) are individually and parallelly read. After reading of the charge accumulated in the pixel of the rightmost line position of the first column in each rectangular areas (b, 1, 1), (c, 1, 1), and (d, 1, 1), charges accumulated in the pixel of the first line position of the second column position in each of the above mentioned rectangular areas is read. The read charges are output from the second, third, and fourth output channels in parallel, respectively.

In group 410a, when charges accumulated in the pixels contained in the rectangular area (a, 1, 1) are read out, charges accumulated in the pixels contained in the rectangular area (a, 2, 1) are read next. Similarly to the foregoing embodiments, the charge accumulation time for the pixels of the rectangular area (a, 2, 1) may be varied from that for the pixels of the rectangular area (a, 1, 1). When charges accumulated in pixels of the rectangular area (a, J-1, 1) are read, charges accumulated in pixels of the rectangular area (a, 1, 2) are read next. When charges accumulated in pixels of the rectangular area (a, J-1, I-1) are read, the charge reading for the pixels contained in the group 410a is completed. In groups 410b, 410c, and 410d, the charge reading starts from the pixels in the rectangular areas (b, 1, 1), (c, 1, 1), and (d, 1, 1) and progresses in a similar manner as described above for the group 410a.

The time necessary to read one frame image can be reduced since the charge readings for the pixels contained in groups 410a, 410b, 410c, and 410d are carried out parallelly and simultaneously. Thus, the deformation of the image of the moving object can be suppressed.

In the same manner as described above in the foregoing embodiments, the image sensor 902 according to the present embodiment can be controlled to change its charge accumulation time (exposure time). This is accomplished by controlling the timing of output of the reset timing signal from reset control register 913. Alternatively, the charge accumulation time can be changed by changing the control timing of the line selection unit 911a and 911b and column selection unit 912a and 912b. Furthermore, there is no need to synchronize the output timing among the first, second, third, and fourth output channels since the signals transmitted by these channels may be input to the ADC 108 individually. Each of these channels can transmit and input the signals to the ADC 108 independently from one another.

In addition, the charge reading can be executed with one or more pixels skipped. The rate of output of charges (time required for outputting charges for one imaging) can be varied in each group 410a, 410b, 410c, or 410d. This modification can be easily achieved for a person skilled in the art. For example, when the shift increment of at least one of the shift registers 901a, 901b, 904a, and 904b for every one charge reading is set greater than one, the charge reading with one or more pixels being skipped is achieved. This imaging with the skipping charge reading results in a reduction of a time required for reading one frame image.

Furthermore, it is possible to arrange such that the charges accumulated in the pixels of particular areas (such as where a principal part of subject is contained) are thoroughly read, and in the rectangular areas other than the above, the charges accumulated in the pixels can be read in a skipped manner. In this case, the information of the skipped pixel can be generated by the digital signal processing circuit 103 through the interpolation technique using information from the neighboring pixels. The generated information can be stored in the memory 106. The principal part of the subject is a portion or portions of the subject which the operator is aiming. The principal part of the subject can be a portion where the focus is correctly adjusted. In this case, in the rectangular areas where the focus is correctly adjusted, all of the charges accumulated in the pixels in the areas are thoroughly read, and in the other rectangular areas where the focus is not correctly adjusted, the charges accumulated in the pixels are read out in a skipped manner. The focus condition of the rectangular area is judged by the focal area detection unit 110 in the digital signal processing circuit 103. The imaging apparatus thus configured, a rapid imaging with high quality can be obtained.

The image sensor 902 according to this embodiment has the line selection register 911, the column selection register 912, and the reset control register 913, each having two units (911a and 911b, 912a and 912b, and 913a and 913b). Note that each of the line selection register 911, the column selection register, and the reset control register 913 may have three or more units. In this case, the image sensor 902 is configured as the image sensor with six or more output channels.

By the above arrangement, the wiring lines required in this embodiment can be made as less as those of the first, second and third embodiments. Also, the circuit size of the shift registers and selectors of this embodiment can be made as small as those of the first, second and third embodiments.

Other than the above, the structure, control, and correction process in the fourth embodiment are the same as those of the first, second or third embodiment.

### APPLICATION IN INDUSTRY

The present invention can be used in any electronic devices having a MOS image sensor with a wide dynamic range by means of a simple arrangement.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. An image sensor comprising:
a light reception unit segmented into a plurality of areas, each area having a plurality of pixels;
an area identification unit operable to identify one of the plurality of areas;
a start timing control unit operable to control a start timing of charge accumulation in the pixels in said identified area; and
an output timing control unit operable to control timing for outputting the charge accumulated in said pixels in the identified area.

2. The image sensor as described in claim 1, wherein said area identification unit is a shift register.

3. The image sensor as described in claim 1, wherein said area identification unit is a decoder.

4. The image sensor as described in claim 1, wherein said start timing control unit includes: a first start timing control unit operable to control the start of charge accumulation in the pixels aligned in a first column in a predefined direction; and a second start timing control unit operable to control the start of charge accumulation in the pixels aligned in a second column adjacent and parallel to the first column, and
wherein said output timing control unit includes: a first output timing control unit operable to control the start of outputting a charge accumulated in the pixels aligned in the first column; and a second output timing control unit operable to control the start of outputting a charge accumulated in the pixels aligned in the second column.

5. The image sensor as described in claim 1, wherein the plurality of areas are divided into P groups, where the P is an integer more than one,
said area identification unit identifies one area in each of the P groups,
said start timing control unit controls the start of charge accumulation in the pixels in said one identified area for each group, and
said output timing control unit controls the start of outputting the charge accumulated in the pixels in said one identified area for each group.

6. An imaging apparatus comprising:
an image sensor comprising:
a light reception unit divided into a plurality of areas, each area having a plurality of pixels;
an area identification unit operable to identify one of the plurality of areas;
a start timing control unit operable to control a start timing of charge accumulation in the pixels in said identified area; and
an output timing control unit operable to control timing for outputting the charge accumulated in said pixels in the identified area;
a control unit operable to control at least one of said area identification unit, said start timing control unit, and said output timing control unit at a specific timing; and
a timing determination unit operable to determine the specific timing;
wherein said timing determination unit is operable to determine the specific timing for each area, and said image sensor is operable to capture an image based on the specific timing.

7. The imaging apparatus as described in claim 6, wherein the specific timing is determined based on an average luminance in each area.

8. The imaging apparatus as described in claim 6, wherein the specific timing is determined based on a focal point.

9. The imaging apparatus as described in claim 6, wherein said control unit is operable to output a first signal, and said start timing control unit is operable to eliminate, based on the first signal, charges accumulated in the pixels in said identified area; and
said control unit is operable to output a second signal, and said output timing control unit is operable to output, based on the second signal, the charges newly accumulated in the pixels in said identified area after the charge elimination, thereby forming an image.

10. The imaging apparatus as described in claim 6, wherein said control unit is operable to output a third signal, and said area identification unit is operable to identify, based on the third signal, said identified area.

11. The image sensor as described in claim 1, wherein said image sensor is a MOS image sensor.

12. The imaging apparatus as described in claim 6, wherein said image sensor is a MOS image sensor.

13. An image sensing method comprising:
segmenting a light reception unit into a plurality of areas, each area having a plurality of pixels;
identifying one of the plurality of areas;
controlling a start timing of charge accumulation in the pixels in said identified area; and
controlling a timing for outputting the charge accumulated in said pixels in the identified area.

14. An imaging method comprising:
segmenting a light reception unit into a plurality of areas, each area having a plurality of pixels;
identifying one of the plurality of areas;
controlling a start timing of charge accumulation in the pixels in said identified area;
controlling a timing for outputting the charge accumulated in said pixels in the identified area;
performing at least one of said identifying, said controlling the start timing of charge accumulation, and said controlling the timing for outputting at a specific time;
determining the specific time; and
capturing an image at said specific time.
